(19) United States
(12) Patent Application Publication
(10) Pub. No.: US 2021/0061602 A1
(43) Pub. Date: Mar. 4, 2021

(54) SHEET CONVEYANCE APPARATUS AND RECORDING MEDIUM

(71) Applicant: Konica Minolta, Inc., Tokyo (JP)

(72) Inventors: Takashi WATANABE, Toyokawa-shi (JP); Takeshi ISHIDA, Toyohashi-shi (JP); Tatsuya EGUCHI, Toyohashi-shi (JP); Toshikazu HIGASHI, Toyokawa-shi (JP); Shigetaka KATO, Shinshiro-shi (JP); Akinori KIMATA, Toyokawa-shi (JP)

(21) Appl. No.: 17/003,399

(22) Filed: Aug. 26, 2020

(30) Foreign Application Priority Data
Aug. 26, 2019 (JP) 2019-153985

(51) Int. Cl. B65H 7/14; G03G 15/00; B65H 5/06

(52) U.S. Cl. CPC B65H 7/14; B65H 5/062; G03G 15/5029

(57) ABSTRACT

A controller causes a sensor unit to perform: a first operation for detecting a front end of a sheet; and a second operation for detecting a type of the sheet performed at a timing that is based on detection of the front end of the sheet in the first operation.

### CROSS REFERENCE TO RELATED APPLICATIONS

The present invention claims priority under 35 U.S.C. § 119 to Japanese Application No. 2019-153985, filed on Aug. 26, 2019, the entire content of which is incorporated herein by reference.

### BACKGROUND

### Technological Field

The present disclosure relates to a sheet conveyance apparatus that detects the type of a sheet that is being conveyed.

### Description of the Related Art

A sheet conveyance apparatus including an image processing apparatus such as a conventional multi-functional peripheral (MFP) includes: a first sensor for detecting the type of a sheet that is being conveyed; and a second sensor disposed upstream from the first sensor for predicting the timing at which the sheet passes through the first sensor.

For example, Japanese Laid-Open Patent Publication No. 2019-66504 discloses an image forming apparatus including: a medium determining sensor for determining the type of a sheet; and a medium sensing sensor detecting a sheet to be conveyed to the medium determining sensor. Based on the detection output from the medium sensing sensor, the image forming apparatus predicts the timing at which a sheet reaches the medium determining sensor.

### SUMMARY

For predicting the timing at which a sheet reaches the medium determining sensor by using a sheet detection output from the medium sensing sensor, it is necessary to provide a certain conveyance distance from the medium sensing sensor to the medium determining sensor. Thereby, a conveyance distance needs to be uselessly provided in the sheet conveyance apparatus.

In order to minimize the conveyance distance, it is conceivable to predict the timing at which a sheet reaches the medium determining sensor by using the detection output from a paper feed sensor that is conventionally installed at a paper feed port of a paper feed cassette located most upstream in a sheet conveyance path. However, there are problems such as variations in the paper feed sensor and/or variations in the installation position of the paper feed sensor. Due to these problems, using the detection output from the paper feed sensor made it difficult to accurately predict the timing at which a sheet reached the medium determining sensor.

In view of the above-described circumstances, there has been a demand for a technique for accurately predicting the timing at which a sheet reaches a sensor unit used for detecting the type of this sheet, without uselessly increasing the sheet conveyance distance.

To achieve at least one of the above-mentioned objects, according to an aspect of the present invention, a sheet conveyance apparatus reflecting one aspect of the present invention comprises: a conveyance path for a sheet; a conveyance unit that conveys the sheet on the conveyance path; a sensor unit that performs a first operation for detecting a front end of the sheet and a second operation for detecting a type of the sheet, and outputs signals indicating results of the first operation and the second operation; and a controller that receives the signals from the sensor unit and detects the front end and the type of the sheet. The controller causes the sensor unit to perform the second operation at a timing that is based on detection of the front end of the sheet in the first operation.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an external appearance of an image forming apparatus 1.

FIG. 2 is a diagram schematically showing an internal configuration of image forming apparatus 1.

FIG. 3 is a diagram showing a hardware configuration of image forming apparatus 1.

FIG. 4 is a diagram for illustrating a configuration of a sensor unit 500.

FIG. 5 is an enlarged view of an optical detection unit in sensor unit 500.

FIG. 6 is an enlarged view of an ultrasonic detection unit in sensor unit 500.

FIG. 7 is a diagram for illustrating the shape of a main conveyance path R0 in sensor unit 500.

FIG. 8 is a diagram for illustrating the shape of main conveyance path R0 in sensor unit 500.

FIG. 9 is a diagram showing drive voltages of the optical detection unit and the ultrasonic detection unit.

FIG. 10 is a diagram for illustrating a timing to start a first operation.

FIG. 11 is a flowchart of a process performed for detecting a type of a recording paper sheet P2 in image forming apparatus 1.

FIG. 12 is a diagram for illustrating an example of a method of determining the type of recording paper sheet P2 by using sampled data.

### DETAILED DESCRIPTION OF EMBODIMENTS

Hereinafter, one or more embodiments of the present invention will be described with reference to the drawings. However, the scope of the invention is not limited to the disclosed embodiments.

In the following, one or more embodiments of a sheet conveyance apparatus will be described with reference to the accompanying drawings. In the following description, the same parts and components will be designated by the same reference characters. Names and functions thereof are also the same. Accordingly, the description thereof will not be repeated.

<1. Schematic Configuration of Image Forming Apparatus>

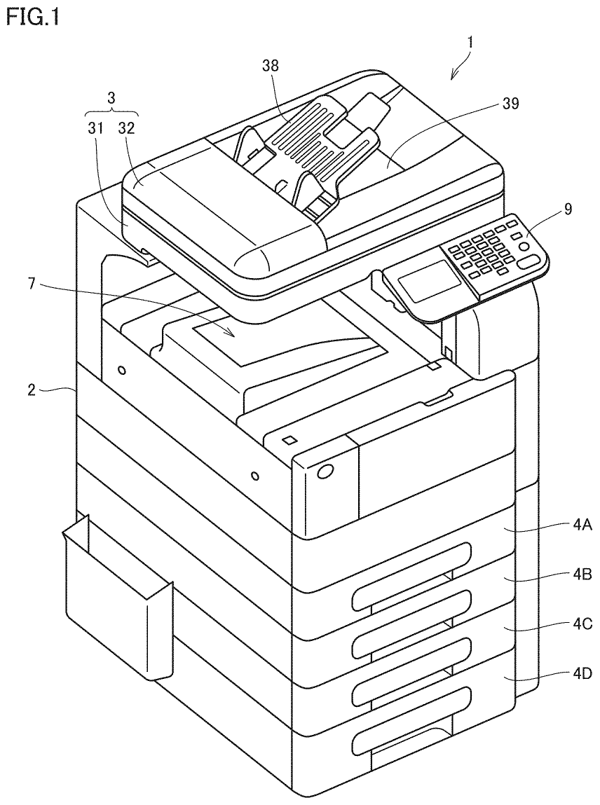

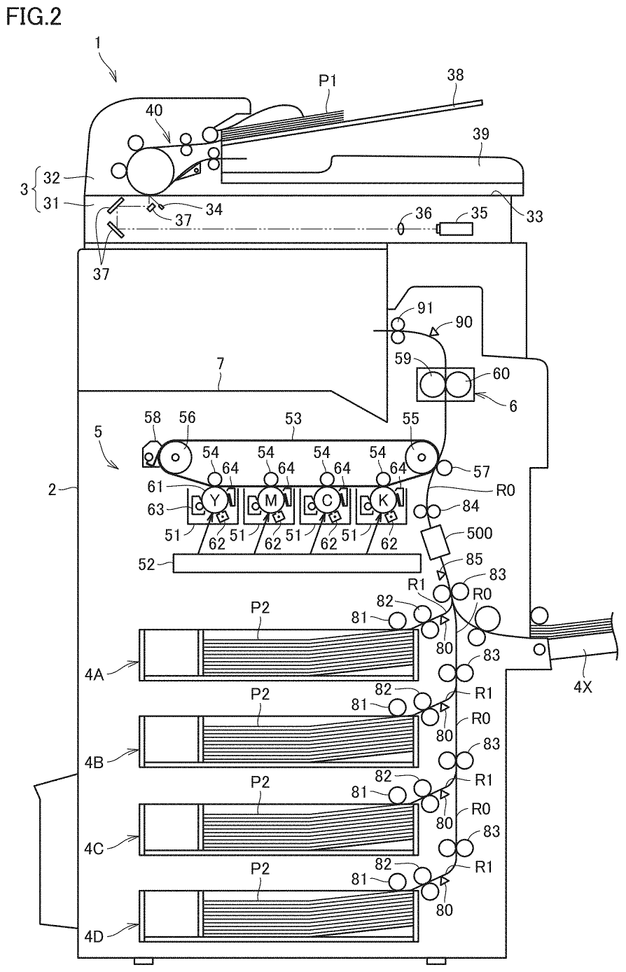

FIG. 1 is a diagram showing an external appearance of an image forming apparatus 1 as one embodiment of a sheet conveyance apparatus of the present disclosure. FIG. 2 is a diagram schematically showing an internal configuration of image forming apparatus 1.

As shown in FIG. 1 and FIG. 2, image forming apparatus 1 includes: an image reading unit 3 that reads an image from a document P1; paper feed cassettes 4A to 4D each containing a recording paper sheet P2 on which an image is formed; a transfer unit 5 that transfers a toner image onto recording paper sheet P2; a fixing unit 6 that fixes the toner image onto recording paper sheet P2 transferred thereto by transfer unit 5; a paper discharge tray 7 to which recording paper sheet P2 having the image fixed thereon by fixing unit 6 is discharged; and an operation panel 9 through which an operation to image forming apparatus 1 is received. Image forming apparatus 1 includes an apparatus main body 2 having: an upper portion including image reading unit 3; and a lower portion including transfer unit 5.

As described above, image forming apparatus 1 includes four paper feed cassettes 4A to 4D. In the present specification, when a common feature of paper feed cassettes 4A to 4D is mentioned, paper feed cassettes 4A to 4D may be collectively referred to as a “paper feed cassette 4”.

In image forming apparatus 1, paper discharge tray 7 is disposed above transfer unit 5 so as to receive recording paper sheet P2 that is discharged after an image is recorded thereon in transfer unit 5 and fixing unit 6. Paper feed cassette 4 is disposed below transfer unit 5. Paper feed cassette 4 is insertable into and removable from apparatus main body 2. In image forming apparatus 1, recording paper sheet P2 stored in paper feed cassette 4 is fed into apparatus main body 2. Recording paper sheet P2 is conveyed upward, and thereby delivered to transfer unit 5 disposed above paper feed cassette 4. Then, an image is transferred onto recording paper sheet P2 in transfer unit 5. Fixing unit 6 fixes the transferred image onto recording paper sheet P2. Recording paper sheet P2 is processed in fixing unit 6 and thereafter discharged to paper discharge tray 7. Paper discharge tray 7 is provided in a space (a recessed space) between image reading unit 3 and transfer unit 5.

Image reading unit 3 includes: a scanner unit 31 that reads the image from document P1; and an auto document feeder (ADF) 32 that is disposed above scanner unit 31 and conveys documents P1 one by one to scanner unit 31. Operation panel 9 is provided on the front side (the front surface side) of apparatus main body 2. With keystrokes while looking at a display screen and the like on operation panel 9, a user can set the function selected from various functions of image forming apparatus 1 and can instruct image forming apparatus 1 to perform an operation.

Referring to FIG. 2, the internal structure of apparatus main body 2 will be hereinafter described. Scanner unit 31 of image reading unit 3 includes: a platen 33 having a platen glass (not shown) on the upper surface side; a light source unit 34 that applies light to document P1; an image sensor 35 that performs photoelectric conversion of the light reflected from document P1 into image data; an image forming lens 36 that focuses the reflected light to form an image on image sensor 35; and a mirror group 37 from which the light reflected from document P1 is sequentially reflected so as to enter image forming lens 36.

Light source unit 34, image sensor 35, image forming lens 36, and mirror group 37 are provided inside platen 33. Light source unit 34 and mirror group 37 are configured to be movable in the horizontal direction with respect to platen 33.

ADF 32 is disposed on the upper surface side of scanner unit 31. ADF 32 can be opened and closed with respect to platen 33 and includes a document mount tray 38 and a document discharge tray 39. ADF 32 is overlaid over document P1 on the platen glass (not shown) of platen 33 and thereby can bring document P1 into close contact with the platen glass (not shown).

When document P1 on the platen glass (not shown) of platen 33 is read in image reading unit 3, document P1 is irradiated with light from light source unit 34 that moves rightward (in a sub-scan direction). The light reflected from document P1 is reflected sequentially by mirror group 37 moving rightward like light source unit 34, and enters image forming lens 36 to thereby form an image on image sensor 35. Image sensor 35 performs photoelectric conversion for each pixel in accordance with the intensity of the incident light to generate an image signal (a red-green-blue (RGB) signal) corresponding to the image on document P1.

On the other hand, when image sensor 35 reads document P1 placed on document mount tray 38, document P1 is conveyed to a reading position by a document conveyance mechanism 40 formed of a plurality of rollers and the like. Light source unit 34 and mirror group 37 in scanner unit 31 are fixed to prescribed positions inside platen 33. Light source unit 34 applies light to the position at which document P1 is read, and the light is reflected to pass through mirror group 37 and image forming lens 36 in scanner unit 31 to thereby form an image on image sensor 35. Then, image sensor 35 converts the reflected light into an image signal (an RGB signal) corresponding to the image on document P1. Then, document P1 is discharged onto document discharge tray 39.

Transfer unit 5 that transfers a toner image onto recording paper sheet P2 includes: imaging units 51 that generate toner images of respective colors including yellow (Y), magenta (M), cyan (C), and key tone (K); an exposure unit 52 provided below imaging units 51; an intermediate transfer belt 53 onto which the toner images of respective colors are transferred from imaging units 51 as this intermediate transfer belt 53 comes into contact with imaging units 51 of respective colors arranged side by side in the horizontal direction; a primarily transfer roller 54 disposed above imaging units 51 of respective colors so as to face imaging units 51 with intermediate transfer belt 53 interposed between primarily transfer roller 54 and each of imaging units 51; a driving roller 55 that causes intermediate transfer belt 53 to rotate; a driven roller 56 that rotates in response to rotation of driving roller 55 transmitted through intermediate transfer belt 53; a secondary transfer roller 57 disposed to face driving roller 55 with intermediate transfer belt 53 interposed therebetween; and a cleaner unit 58 disposed to face driven roller 56 with intermediate transfer belt 53 interposed therebetween.

Each of imaging units 51 includes: a photoconductor drum 61 that comes into contact with the outer circumferential surface of intermediate transfer belt 53; a charging unit 62 that charges the outer circumferential surface of photoconductor drum 61 by corona discharge; a developing unit 63 that causes toner, which has been stirred and thereby charged, to adhere to the outer circumferential surface of photoconductor drum 61; and a cleaner unit 64 that removes toner remaining on the outer circumferential surface of photoconductor drum 61 after the toner image is transferred onto intermediate transfer belt 53. In this case, photoconductor drum 61 is disposed to face primarily transfer roller 54 with intermediate transfer belt 53 interposed therebetween, and rotates in the clockwise direction in FIG. 2. Primarily transfer roller 54, cleaner unit 64, charging unit 62, and developing unit 63 are disposed sequentially around photoconductor drum 61 so as to extend in the rotation direction of photoconductor drum 61.

Intermediate transfer belt 53 is formed of a belt member having electrical conductivity and formed in an endless shape, for example. Intermediate transfer belt 53 passes over driving roller 55 and driven roller 56 with no slack, and thereby rotates in the counterclockwise direction in FIG. 2 as driving roller 55 rotates. Secondary transfer roller 57, cleaner unit 58, and imaging units 51 of respective colors of Y, M, C, and K are disposed sequentially around intermediate transfer belt 53 so as to extend in the rotation direction of intermediate transfer belt 53.

Fixing unit 6 fixes the toner image transferred onto recording paper sheet P2. Fixing unit 6 includes: a heating roller 59 including a halogen lamp and the like for heating the toner image on recording paper sheet P2 so as to be fixed thereto; and a pressurizing roller 60 that pressurizes recording paper sheet P2 in the state where recording paper sheet P2 is sandwiched between this pressurizing roller 60 and heating roller 59. Heating roller 59 may generate an eddy current on its surface by electromagnetic induction so as to heat this surface.

In image forming apparatus 1, paper feed cassettes 4A to 4D are connected to respective paper feed paths R1. The conveyance apparatus that conveys recording paper sheet P2 includes: a pull-out roller 81 that pulls out uppermost one of recording paper sheets P2 stored in each of paper feed cassettes 4A to 4D so as to be directed to paper feed path R1; a paper feed roller pair 82 that delivers the pulled out recording paper sheet P2 further to paper feed path R1; a conveyance roller pair 83 that vertically conveys recording paper sheet P2, which has been delivered by paper feed roller pair 82, on a main conveyance path R0; and a skew correction roller 84 that is disposed downstream from conveyance roller pair 83 on main conveyance path R0 and serves to convey recording paper sheet P2 toward transfer unit 5. Each of paper feed cassettes 4A to 4D is provided with a paper feed sensor 80 for detecting recording paper sheet P2 that is pulled out from each paper feed cassette.

Main conveyance path R0 is a main conveyance path for recording paper sheet P2 in the image formation (printing) process. Paper feed path R1 is provided for each of paper feed cassettes 4A to 4D. Each paper feed path R1 merges with main conveyance path R0. Paper feed path R1 is one example of the conveyance path.

As pull-out roller 81 corresponding to each of paper feed cassettes 4A to 4D is driven to rotate, the uppermost one of recording paper sheets P2 in each of paper feed cassettes 4A to 4D is pulled out one by one to be delivered to corresponding paper feed path R1 and then delivered by corresponding paper feed roller pair 82 toward main conveyance path R0. Paper feed sensor 80 detects recording paper sheet P2 that has been delivered from each of paper feed cassettes 4A to 4D to corresponding paper feed path R1.

Image forming apparatus 1 further includes a manual feed tray 4X. In image forming apparatus 1, the conveyance apparatus can also deliver recording paper sheets P2 placed on manual feed tray 4X to main conveyance path R0 in the same manner as with recording paper sheets P2 placed on each of paper feed cassettes 4A to 4D.

On main conveyance path R0, as conveyance roller pair 83 is driven to rotate, recording paper sheet P2 conveyed from paper feed roller pair 82 is conveyed toward skew correction roller 84 disposed in front of transfer unit 5. In order to allow transfer unit 5 to normally transfer the toner image onto recording paper sheet P2, skew correction roller 84 conveys recording paper sheet P2 to transfer unit 5 in synchronization with the timing at which the toner image is formed in transfer unit 5. In other words, when a recording paper sheet is conveyed by conveyance roller pair 83 to skew correction roller 84, skew correction roller 84 is stopped to cause recording paper sheet P2 to become slack to thereby form a loop. Then, the skew of the recording paper sheet is corrected by this loop, and then, the recording paper sheet is conveyed to secondary transfer roller 57.

On main conveyance path R0, a conveyance sensor (a recording paper sheet detection unit) 85 is disposed above conveyance roller pair 83 (on the downstream side in the conveyance direction). Conveyance sensor 85 is for detecting recording paper sheet P2 that is vertically conveyed by conveyance roller pair 83. Skew correction roller 84 is one example of a resist roller.

A sensor unit 500 is provided below skew correction roller 84 (on the upstream side in the conveyance direction). Sensor unit 500 includes a sensor as described below. In image forming apparatus 1, the type of recording paper sheet P2 may be detected based on the signal from this sensor in sensor unit 500. In image forming apparatus 1, the process control conditions (the conveyance speed of recording paper sheet P2, and the like) for formation of an image on recording paper sheet P2 are set based on the detection result about the type of recording paper sheet P2.

Based on the signal from sensor unit 500, image forming apparatus 1 detects the front end of recording paper sheet P2 that has reached the position immediately in front of skew correction roller 84. Then, based on the timing at which recording paper sheet P2 reaches skew correction roller 84 from sensor unit 500, image forming apparatus 1 may perform paper sheet conveyance and loop control on main conveyance path R0.

Also, a paper discharge roller pair 91 for discharging printed recording paper sheet P2 is disposed at the end portion on the lowermost downstream side in main conveyance path R0. Printed recording paper sheet P2 is discharged to paper discharge tray 7 as paper discharge roller pair 91 is driven to rotate. Furthermore, a paper discharge sensor 90 for detecting the trailing end of recording paper sheet P2 is disposed below paper discharge roller pair 91 (on the upstream side in the conveyance direction) on main conveyance path R0. Thus, paper discharge sensor 90 detects the trailing end of recording paper sheet P2, and thereby, it may be confirmed that recording paper sheet P2 has been normally discharged from paper discharge roller pair 91 to paper discharge tray 7.

<2. Hardware Configuration of Image Forming Apparatus>

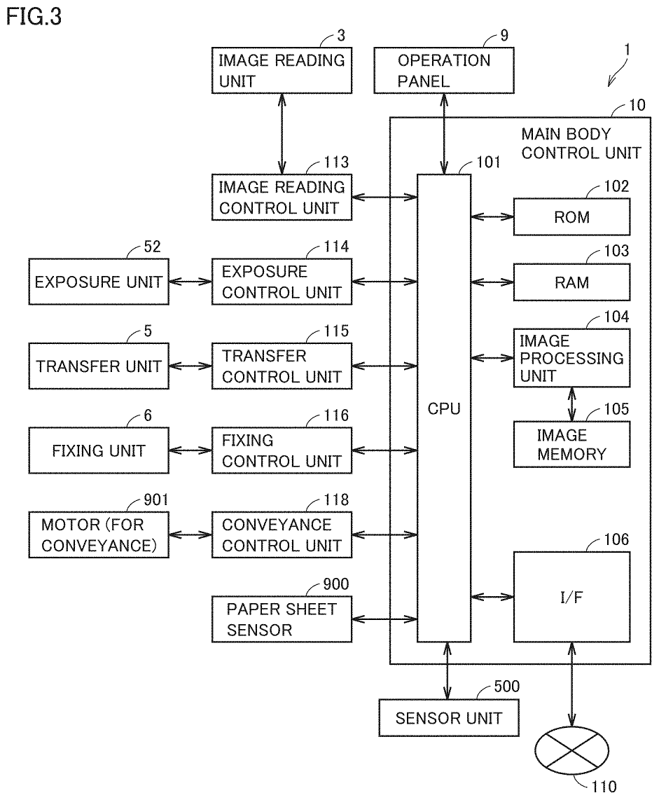

FIG. 3 is a diagram showing a hardware configuration of image forming apparatus 1. Image forming apparatus 1 includes a main body control unit 10 (a controller) having the configuration shown in FIG. 3. Main body control unit 10 controls each of components constituting image forming apparatus 1. Thereby, various types of operations in image forming apparatus 1 (an operation of printing on recording paper sheet P2, an operation of reading an image from document P1, and the like) are performed.

Main body control unit 10 includes: a central processing unit (CPU) 101 that performs various computing processes and controls; a read only memory (ROM) 102 that stores a control program and the like; a random access memory (RAM) 103 that temporarily stores computation data; an image processing unit 104 that generates image data as a base of a toner image to be formed in transfer unit 5; an image memory 105 that temporarily stores the image data obtained in image processing unit 104; and an input/output interface 106 through which a signal is transmitted to and received from each of the components constituting image forming apparatus 1.

Upon reception of the signal corresponding to the operation received through operation panel 9, CPU 101 identifies the operation corresponding to the operation received through operation panel 9. Similarly, when main body control unit 10 receives, through input/output interface 106, a signal transmitted from an external terminal and the like over a communication network 110 such as a local area network (LAN), this main body control unit 10 identifies the operation designated by the external terminal. Thereby, from ROM 102, CPU 101 reads the control program that is based on the operation designated through operation panel 9 or the external terminal. Then, CPU 101 operates based on the control program.

Based on the control program read from ROM 102, CPU 101 outputs signals to an image reading control unit 113, an exposure control unit 114, a transfer control unit 115, a fixing control unit 116, and a conveyance control unit 118 that control driving of image reading unit 3, exposure unit 52, transfer unit 5, fixing unit 6, and a motor (for conveyance) 901, respectively. Thus, in image forming apparatus 1, main body control unit 10 sends signals to image reading control unit 113, exposure control unit 114, transfer control unit 115, and fixing control unit 116 to thereby drive image reading unit 3, exposure unit 52, transfer unit 5, and fixing unit 6, respectively, according to the respective designated operations. In image forming apparatus 1, main body control unit 10 sends a signal to conveyance control unit 118 to thereby drive rotation of pull-out roller 81, roller pairs 82, 83, and 91, and skew correction roller 84 in the conveyance apparatus. Motor 901 serves to drive various types of rollers for conveyance of recording paper sheets in image forming apparatus 1. Various types of rollers may be driven as CPU 101 controls the operation of motor 901 through conveyance control unit 118.

Sensor unit 500 is connected to CPU 101. CPU 101 controls the operation of sensor unit 500 and detects the type of recording paper sheet P2 based on the signal from sensor unit 500.

<3. Print Operation of Image Forming Apparatus>

Then, the print operation by image forming apparatus 1 will be described below. When image forming apparatus 1 receives an instruction to perform a print operation through operation panel 9 or an external terminal, main body control unit 10 causes CPU 101 to read a control program for the print operation from ROM 102 so as to start the control operation for the print operation. First, through conveyance control unit 118, CPU 101 controls driving of the conveyance apparatus, to thereby pull out an uppermost recording paper sheet P2 from paper feed cassette 4 and deliver this pulled-out uppermost recording paper sheet P2 to main conveyance path R0.

In order to transfer a toner image onto recording paper sheet P2 delivered to main conveyance path R0, CPU 101 sends control signals to exposure control unit 114 and transfer control unit 115 so as to control driving of exposure unit 52 and transfer unit 5, respectively. In this case, CPU 101 provides image processing unit 104 with: an image signal read from document P1 by image reading unit 3 through image reading control unit 113; or an image signal received from the external terminal through input/output interface 106.

Thereby, based on the provided image signals, image processing unit 104 generates image data for forming toner images of respective colors of Y, M, C, and K. Then, each generated image data is stored in image memory 105. The image data of each of respective colors of Y, M, C, and K stored in image memory 105 is read by CPU 101 and sent to exposure control unit 114. Thus, exposure control unit 114 drives a light emitting element (not shown) in exposure unit 52 based on the image data of each of respective colors of Y, M, C, and K, to thereby form an electrostatic latent image on each of photoconductor drums 61 of respective colors of Y, M, C, and K. In other words, as transfer control unit 115 drives transfer unit 5, exposure unit 52 emits a laser beam onto each of the surfaces of photoconductor drums 61 electrically charged by respective charging units 62 in imaging units 51 of respective colors of Y, M, C, and K, so as to form electrostatic latent images corresponding to the images of respective colors of Y, M, C, and K.

Then, toner electrically charged in developing unit 63 is transferred to each of the surfaces of photoconductor drums 61 on which the respective electrostatic latent images are formed. Thereby, toner images are formed on respective photoconductor drums 61 each serving as the first image carrier. Then, upon contact with intermediate transfer belt 53, the toner images carried on the surfaces of respective photoconductor drums 61 are transferred onto intermediate transfer belt 53 by electrostatic force of primarily transfer roller 54. This leads to formation of a toner image formed by the toner images of respective colors of Y, M, C, and K superimposed on the surface of intermediate transfer belt 53 serving as the second image carrier. On the other hand, some toner remains untransferred on each of photoconductor drums 61 from which the toner images have been transferred to intermediate transfer belt 53. Such untransferred toner is scratched off by cleaner unit 64 and removed from each photoconductor drum 61.

When the front end of recording paper sheet P2 conveyed along main conveyance path R0 is detected based on the signal from sensor unit 500, the detection result is given to transfer control unit 115. Thereby, transfer control unit 115 recognizes that recording paper sheet P2 has reached skew correction roller 84. Transfer control unit 115 causes skew correction roller 84 to operate according to the timing at which the toner images are transferred onto intermediate transfer belt 53. In this case, as intermediate transfer belt 53 is rotated by driving roller 55 and driven roller 56, the toner image transferred onto intermediate transfer belt 53 is moved to a transfer position at which the toner image comes into contact with secondary transfer roller 57. Then, the toner image is transferred onto recording paper sheet P2 that is conveyed to the transfer position on main conveyance path R0. Also, some toner remains untransferred on intermediate transfer belt 53 from which the toner image has been transferred onto recording paper sheet P2. Such untransferred toner is scratched off by cleaner unit 58 and removed from intermediate transfer belt 53.

After the toner image is transferred onto recording paper sheet P2 at the position of contact with secondary transfer roller 57, this recording paper sheet P2 is conveyed to fixing unit 6 functioning by heating roller 59 and pressurizing roller 60. In this case, CPU 101 controls driving of fixing unit 6 through fixing control unit 116 so as to fix the toner image on recording paper sheet P2 conveyed to fixing unit 6. In other words, fixing control unit 116 controls the rotation operations of heating roller 59 and pressurizing roller 60 and, at the same time, controls the heating operation of heating roller 59.

Thereby, while passing through a fixing nip portion of fixing unit 6, recording paper sheet P2 having an unfixed toner image transferred thereon is heated by heating roller 59 and pressurized by pressurizing roller 60, with the result that the unfixed toner image is fixed onto the surface of the paper sheet. Then, recording paper sheet P2 having the toner image fixed thereto (after one-side printing) is conveyed to paper discharge roller pair 91, and thereafter, discharged by paper discharge roller pair 91 to paper discharge tray 7. At this time, paper discharge sensor 90 detects the trailing end of recording paper sheet P2, and the detection result thereof is sent to main body control unit 10. Thereby, main body control unit 10 confirms that recording paper sheet P2 has been normally discharged to paper discharge tray 7.

<4. Configuration of Sensor Unit 500>

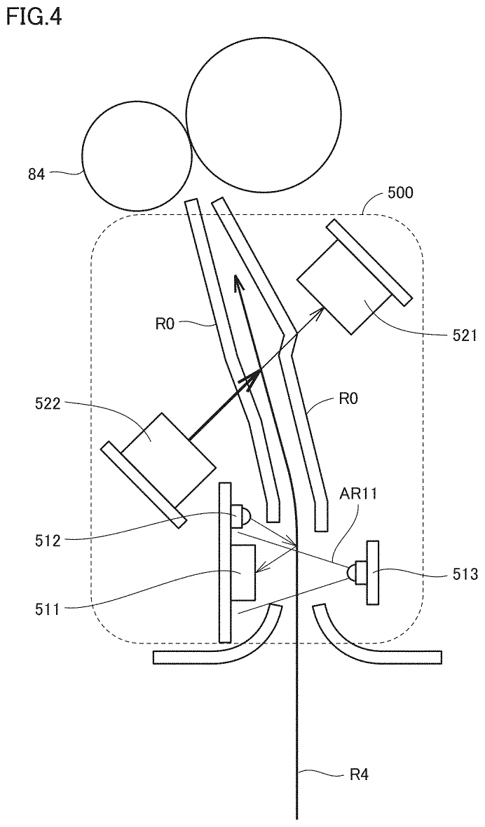

FIG. 4 is a diagram for illustrating the configuration of sensor unit 500. In FIG. 4, an arrow R4 indicates the conveyance direction of recording paper sheet P2 on main conveyance path R0. Sensor unit 500 includes: an optical detection unit that outputs a signal based on optical detection; and an ultrasonic detection unit that outputs a signal based on detection through use of ultrasonic waves.

(Optical Detection Unit)

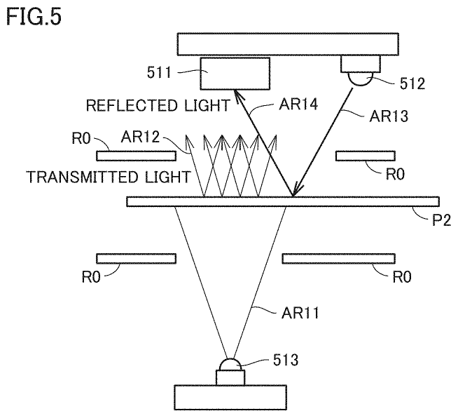

FIG. 5 is an enlarged view of the optical detection unit in sensor unit 500. The optical detection unit includes a light receiver 511 and light sources 512, 513. Light receiver 511 includes a charge coupled device (CCD) sensor, for example. Light sources 512 and 513 each include a light emitting diode (LED) element, for example.

With reference to main conveyance path R0, light source 512 is disposed on the same side as light receiver 511. In FIG. 5, an arrow AR13 shows light emitted from light source 512, and an arrow AR14 shows light, which is indicated as arrow AR13, reflected on recording paper sheet P2 and traveling toward light receiver 511. Light receiver 511 detects the light output from light source 512 and reflected from recording paper sheet P2 on main conveyance path R0.

With reference to main conveyance path R0, light source 513 is disposed on the side opposite to light receiver 511. In FIG. 5, a region AR11 shows light emitted by light source 513, and an arrow AR12 shows light, which is indicated as region AR11, penetrating through recording paper sheet P2 and traveling toward light receiver 511. Light receiver 511 detects the light that has been output from light source 513, passed through main conveyance path R0 and reached light receiver 511. When recording paper sheet P2 exists between light receiver 511 and light source 513, light receiver 511 detects the light that has been output from light source 513 and penetrated through recording paper sheet P2.

Light receiver 511 outputs, to CPU 101, the signal showing the result about detection of the light from light source 512 and/or light source 513 (the signal corresponding to the amount of light received by light receiver 511). Based on the signal from light receiver 511, CPU 101 specifies the timing at which the front end of recording paper sheet P2 has reached the inside of sensor unit 500, detects the basis weight of recording paper sheet P2 in sensor unit 500, and detects that each recording paper sheet P2 in sensor unit 500 is a specific type of sheet (for example, a transparent sheet for over head projector (OHP)).

In the present specification, the operation for detecting the front end of recording paper sheet P2 by the optical detection unit will be referred to as the “first operation”, and the operation for detecting the basis weight of recording paper sheet P2 and/or for detecting the type of sheet will be referred to as the “second operation”.

(Ultrasonic Detection Unit)

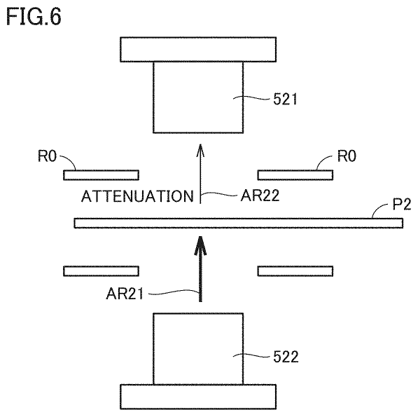

FIG. 6 is an enlarged view of the ultrasonic detection unit in sensor unit 500. The ultrasonic detection unit includes a transmitter 522 that transmits ultrasonic waves. Furthermore, the ultrasonic detection unit includes a receiver 521 that receives ultrasonic waves and outputs a signal corresponding to the strength of the received ultrasonic waves.

In FIG. 6, an arrow AR21 shows the ultrasonic waves output from transmitter 522. An arrow AR22 shows the ultrasonic waves obtained as a result of attenuation of the ultrasonic waves (shown by arrow AR21) by recording paper sheet P2. Receiver 521 detects the ultrasonic waves output from transmitter 522. When recording paper sheet P2 exists between light receiver 511 and transmitter 522, receiver 521 detects the ultrasonic waves that are attenuated by recording paper sheet P2 after emission from transmitter 522.

Receiver 521 outputs the signal corresponding to the strength of the detected ultrasonic waves to CPU 101. Based on the signal from receiver 521, CPU 101 detects that the front end of recording paper sheet P2 exists between receiver 521 and transmitter 522, and also, detects the type of recording paper sheet P2 (an envelope, two or more recording paper sheets superimposed on one another, and the like).

In the present specification, the operation for detecting the front end of recording paper sheet P2 by the ultrasonic detection unit will be referred to as the “first operation”, and the operation for detecting the basis weight of recording paper sheet P2 and/or detecting the type of sheet will be referred to as the “second operation”.

In other words, in the present specification, each of the optical detection unit and the ultrasonic detection unit may perform the “first operation” and the “second operation”.

As shown in FIG. 4 and the like, image forming apparatus 1 may include both the optical detection unit and the ultrasonic detection unit, or may include only one of the optical detection unit and the ultrasonic detection unit.

In FIG. 4, the optical detection unit is disposed upstream from the ultrasonic detection unit on the conveyance path for recording paper sheet P2. It is to be noted that the ultrasonic detection unit may be disposed upstream from the optical detection unit.

CPU 101 may use one of the optical detection unit and the ultrasonic detection unit to detect the front end of recording paper sheet P2 in sensor unit 500, or may use the other one of the optical detection unit and the ultrasonic detection unit to detect the type of recording paper sheet P2. In this case, CPU 101 may detect the front end of recording paper sheet P2 using the detection unit on the downstream side, and based on this detection of the front end of recording paper sheet P2, may detect the type of recording paper sheet P2 using the detection unit on the upstream side.

<5. Timing to Detect Type of Recording Paper Sheet in Sensor Unit 500>

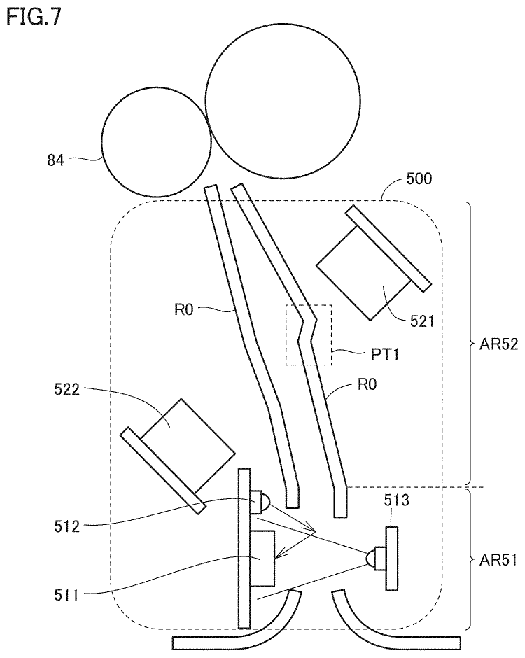

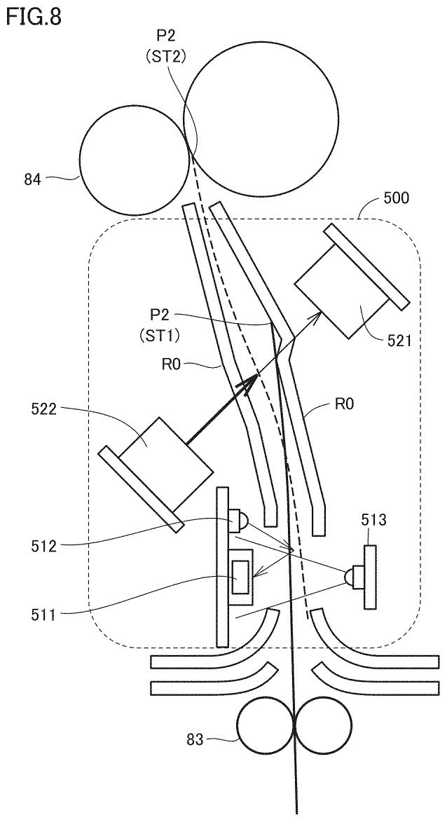

FIG. 7 and FIG. 8 each are a diagram for illustrating the shape of main conveyance path R0 in sensor unit 500. As shown in FIG. 7, main conveyance path R0 in sensor unit 500 has a recess PT1.

As shown as a state ST1 in FIG. 8, the front end of recording paper sheet P2 may come into contact with the portion in the vicinity of recess PT1 as recording paper sheet P2 is conveyed on main conveyance path R0 as indicated by arrow R4 in FIG. 4. This contact may cause an impact on recording paper sheet P2.

FIG. 8 shows a state ST2 as the state of recording paper sheet P2 that is further conveyed from state ST1. In state ST2, the front end of recording paper sheet P2 is located at a position immediately in front of a nip portion of the roller pair that forms skew correction roller 84.

In image forming apparatus 1, the front end of recording paper sheet P2 may be detected before recording paper sheet P2 reaches state ST1. The type of recording paper sheet P2 may be detected in a time period during which recording paper sheet P2 is located in a range from the position at which the above-mentioned impact is predicted to converge to the position shown as state ST1 (the type detection range). The time period in which recording paper sheet P2 is located in the type detection range is one example of a “prescribed time period”.

In one implementation, CPU 101 detects the front end of recording paper sheet P2 based on the signal from at least one of the optical detection unit and the ultrasonic detection unit (a first timing). Then, based on the conveyance speed and the like, CPU 101 derives the time period during which recording paper sheet P2 is located in the above-mentioned type detection range. Then, CPU 101 causes at least one of the optical detection unit and the ultrasonic detection unit to perform the second operation (a second timing) in the derived time period, obtains a signal from at least one of the optical detection unit and the ultrasonic detection unit, and detects the type of recording paper sheet P2 based on the obtained signal.

In other words, detection of the type of recording paper sheet P2 may be avoided from being conducted in the time period during which an impact occurs in recording paper sheet P2 due to contact with the portion in the vicinity of recess PT1. This may avoid detection accuracy deterioration resulting from the impact, so that the detection accuracy for the type of recording paper sheet P2 may be improved.

<6. Shape of Main Conveyance Path R0 and Arrangement of Each Detection Unit in Sensor Unit 500>

As shown in FIG. 7, main conveyance path R0 may have two portions corresponding to two respective sections AR51 and AR52 into which sensor unit 500 is divided. The portion of main conveyance path R0 that corresponds to section AR51 (the first portion) is located upstream from the portion of main conveyance path R0 that corresponds to section AR52 (the second portion).

In the example in FIG. 7, the position at which light receiver 511 faces main conveyance path R0 belongs to section AR51. In other words, the optical detection unit outputs a signal that changes depending on whether a sheet exits or not at the position within section AR51.

On the other hand, in the example in FIG. 7, the position at which receiver 521 faces main conveyance path R0 belongs to section AR52. In other words, the ultrasonic detection unit outputs a signal that changes depending on whether a sheet exits or not at the position within section AR52.

As understood from FIG. 7, in the portion of main conveyance path R0 that corresponds to section AR51, recording paper sheet P2 is conveyed upward approximately in the vertical direction. In the portion of main conveyance path R0 that corresponds to section AR52, recording paper sheet P2 is conveyed to the upper left with respect to the conveyance direction in the portion of main conveyance path R0 that corresponds to section AR51. In other words, the angle to the vertical direction at which recording paper sheet P2 is conveyed on the portion (the first portion) of main conveyance path R0 that corresponds to section AR51 is different from the angle to the vertical direction at which recording paper sheet P2 is conveyed on the portion (the second portion) of main conveyance path R0 that corresponds to section AR52.

In image forming apparatus 1, the ultrasonic detection unit may be disposed upstream from the optical detection unit. In this case, the ultrasonic detection unit may be disposed in the first portion, and the optical detection unit may be disposed in the second portion.

Furthermore, image forming apparatus 1 may include only one detection unit of the optical detection unit and the ultrasonic detection unit. In this case, the detection unit is to detect the front end and the type of the sheet in only one of the first portion and the second portion.

<7. Control for First Operation and Second Operation>

As described above, for each of the optical detection unit and the ultrasonic detection unit, the “first operation” for detecting the front end of recording paper sheet P2 and the “second operation” for detecting the type of recording paper sheet P2 are defined. In the following, an explanation will be given as to how to control each of the optical detection unit and the ultrasonic detection unit in the first operation and the second operation.

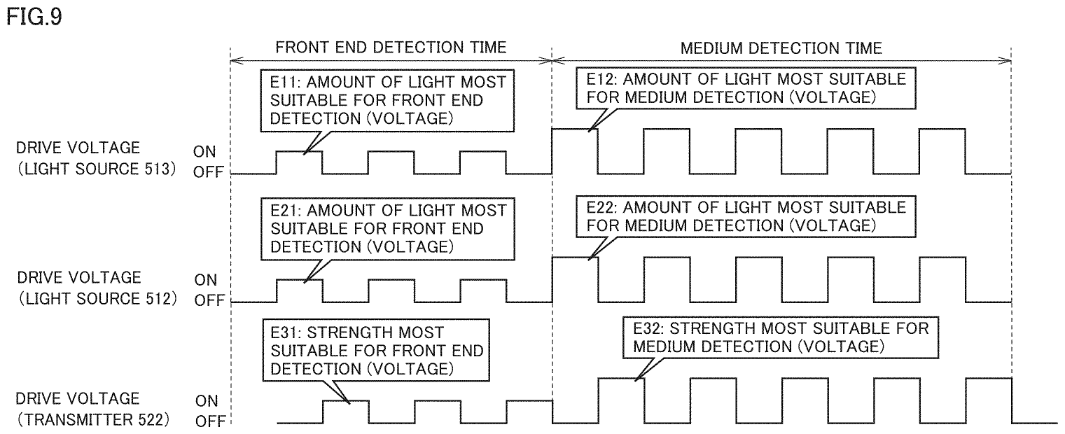

FIG. 9 is a diagram showing drive voltages of the optical detection unit and the ultrasonic detection unit. FIG. 9 shows three graphs arranged in the direction from top to bottom. FIG. 9 shows a drive voltage of light source 513, a drive voltage of light source 512, and a drive voltage of transmitter 522 in this order from the top.

In FIG. 9, the “front end detection time” and the “medium detection time” are defined for each of three graphs. The “front end detection time” shows the time period of the “first operation”. The “medium detection time” shows the time period of the “second operation”.

As understood from the shapes of three graphs shown in FIG. 9, light source 513, light source 512 and transmitter 522 each are driven using pulses.

More specifically, light source 513 is driven by a pulse wave of a voltage E11 in the front end detection time, and driven by a pulse wave of a voltage E12 in the medium detection time. Voltage E11 is smaller than voltage E12. Light source 512 is driven by a pulse wave of a voltage E21 in the front end detection time, and driven by a pulse wave of a voltage E22 in the medium detection time. Voltage E21 is smaller than voltage E22. Transmitter 522 is driven by a pulse wave of a voltage E31 in the front end detection time, and driven by a pulse wave of a voltage E32 in the medium detection time. Voltage E31 is smaller than voltage E32.

In other words, in the front end detection time, each of light source 513, light source 512 and transmitter 522 is driven with the voltage lower than that in the medium detection time. Thereby, light source 513 and light source 512 each are controlled such that the amount of light output therefrom is lower in the front end detection time than in the medium detection time. Transmitter 522 is controlled such that the transmission strength of ultrasonic waves is lower in the front end detection time than in the medium detection time.

In the front end detection time, only existence and non-existence of recording paper sheet P2 has to be detected, and therefore, the front end may be sufficiently detected with a small amount of light and/or ultrasonic waves with low strength. Furthermore, in the case of relatively thin recording paper sheet P2, when a large amount of light and/or ultrasonic waves with high strength are/is output, no significant difference appears in the detection result of light receiver 511 and/or receiver 521 depending on recording paper sheet P2. Thus, it may also be conceivable that the front end of recording paper sheet P2 may not be detected. On the other hand, in the medium detection time (sheet type detection time), a certain amount of light and/or ultrasonic waves with certain strength are/is required for obtaining the detection result in accordance with the sheet type.

As described above, the drive voltage is controlled as shown in FIG. 9, and thereby, the minimum necessary voltage in each of the front end detection time and the medium detection time may be supplied to each of light source 513, light source 512, and transmitter 522. In particular, supply of an unnecessarily high voltage may be avoided in the front end detection time. Thereby, power consumption saving and a prolonged lifetime of each detection unit may be expected.

In the front end detection time, only one of the optical detection unit and the ultrasonic detection unit may be utilized, or both the optical detection unit and the ultrasonic detection unit may be utilized. When both the detection units are utilized, the detection timings of the optical detection unit and the ultrasonic detection unit may be controlled so as not to coincide with each other. More specifically, as shown in the front end detection time in FIG. 9, the timings may be controlled such that the timing to turn on light source 512 and/or light source 513 does not coincide with the timing to turn on transmitter 522. Furthermore, when both light source 512 and light source 513 are utilized, the timings may be controlled such that the timing to turn on light source 512 does not coincide with the timing to turn on light source 513.

Also in the medium detection time, only one of the optical detection unit and the ultrasonic detection unit may be utilized, or both the optical detection unit and the ultrasonic detection unit may be utilized. When both the detection units are utilized, the detection timings of the optical detection unit and the ultrasonic detection unit may be controlled so as not to coincide with each other. More specifically, as shown in the medium detection time in FIG. 9, the timings may be controlled such that the timing to turn on light source 512 and/or light source 513 does not coincide with the timing to turn on transmitter 522. Furthermore, when both light source 512 and light source 513 are utilized, the timings may be controlled such that the timing to turn on light source 512 does not coincide with the timing to turn on light source 513.

<8. Timing to Start First Operation>

As understood mainly from FIG. 2, the conveyance distances of recording paper sheet P2 from respective paper feed cassettes 4A to 4D to sensor unit 500 are different. For example, the conveyance distance of recording paper sheet P2 from paper feed cassette 4D to sensor unit 500 is longer than the conveyance distance of recording paper sheet P2 from paper feed cassette 4A to sensor unit 500. In image forming apparatus 1, based on the difference among these conveyance distances, the timing to start the first operation may be controlled based on which one of paper feed cassettes 4A to 4D from which a paper sheet intended for image formation is pulled out.

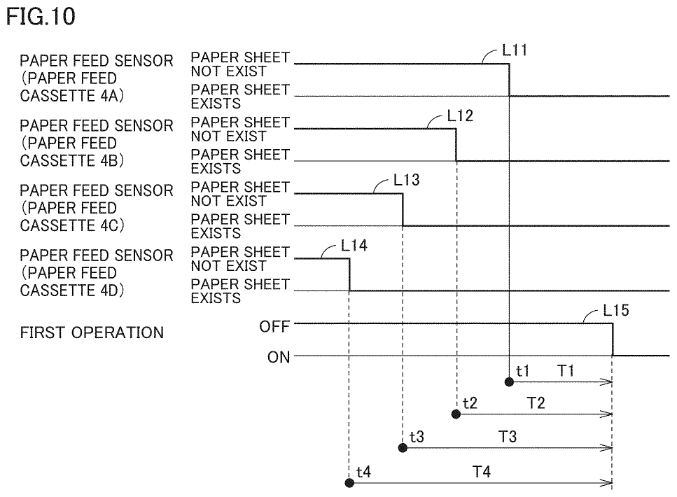

FIG. 10 is a diagram for illustrating a timing to start the first operation. FIG. 10 shows: a detection output from paper feed sensor 80 provided in each of paper feed cassettes 4A to 4D; and a control signal for CPU 101 to cause the optical detection unit and/or the ultrasonic detection unit to perform the first operation.

More specifically, graphs L11, L12, L13, and L14 in FIG. 10 show the detection outputs from paper feed sensors 80 that detect each recording paper sheet P2 pulled out from paper feed cassettes 4A, 4B, 4C, and 4D, respectively. For example, graph L11 shows the detection output from paper feed sensor 80 that detects recording paper sheet P2 pulled out from paper feed cassette 4A. In the example in FIG. 10, paper feed sensor 80 of paper feed cassette 4A starts to detect recording paper sheet P2 from time t1. Paper feed sensors 80 for respective paper feed cassettes 4B, 4C, and 4D start to detect recording paper sheets P2 from time t2, time t3, and time t4, respectively.

A graph L15 shows a control signal for CPU 101 to cause the optical detection unit and/or the ultrasonic detection unit to perform the first operation. In the example in FIG. 10, CPU 101 causes the optical detection unit and/or the ultrasonic detection unit to perform the first operation from time t5.

In the example in FIG. 10, the time intervals from detection of recording paper sheet P2 by paper feed sensor 80 to the start of the first operation (from time t1, time t2, time t3, and time t4 to time t5) are shown as time periods T1, T2, T3, and T4, respectively. For example, the time interval from time t1 to time t5 is shown as time period T1. The time intervals from time t2, time t3, and time t4 to time t5 are shown as time periods T2, T3, and T4, respectively.

The above-mentioned time intervals are different depending on which one of paper feed cassettes 4A to 4D from which recording paper sheet P2 is pulled out. More specifically, the time interval is shortest (time period T1) in the case where recording paper sheet P2 is pulled out from paper feed cassette 4A, and longest (time period T4) in the case where recording paper sheet P2 is pulled out from paper feed cassette 4D. Thereby, the timing to start the first operation is controlled in accordance with the timing at which recording paper sheet P2 pulled out from the paper feed cassette reaches sensor unit 500. This consequently minimizes the time period during which the first operation is performed uselessly before recording paper sheet P2 reaches sensor unit 500.

<9. Process Flow>

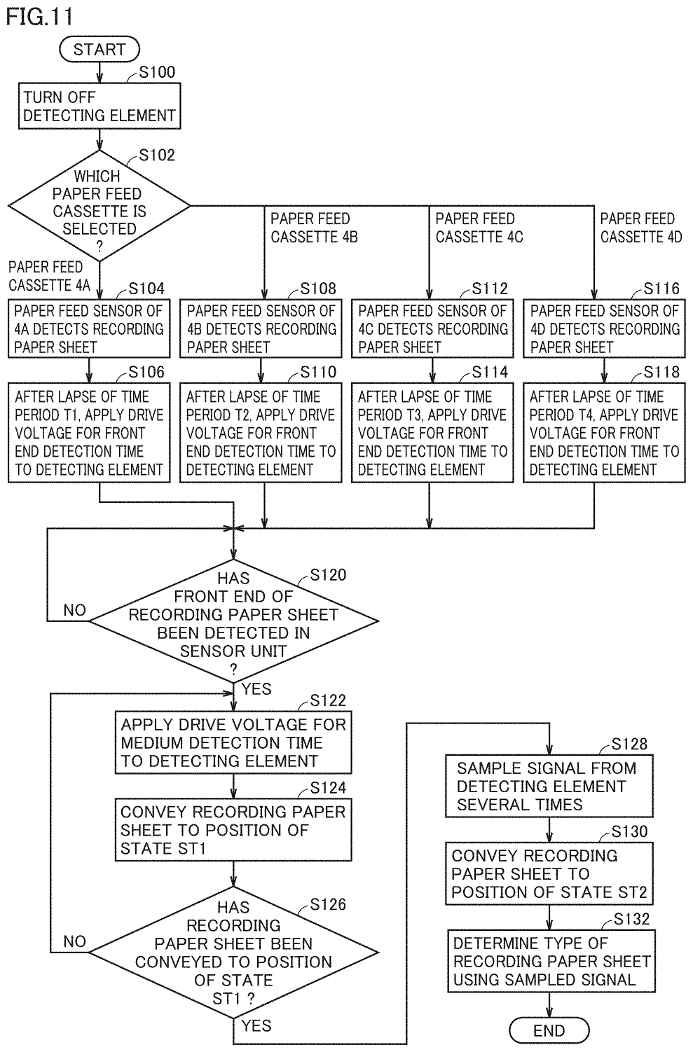

FIG. 11 is a flowchart of a process performed for detecting the type of recording paper sheet P2 in image forming apparatus 1. In one implementation, CPU 101 executes a prescribed program to cause image forming apparatus 1 to perform the process in FIG. 11. CPU 101 starts the process in FIG. 11, for example, as image forming apparatus 1 has received an instruction to form an image on recording paper sheet P2.

In one implementation for the process in FIG. 11, in image forming apparatus 1, elements utilized for detecting the front end and the type of recording paper sheet P2 are set in advance from among the elements in the optical detection unit and the ultrasonic detection unit. One example of the elements is a combination of light receiver 511 and light source 512. Another example of the elements is a combination of light receiver 511 and light source 513. Still another example of the elements is a combination of receiver 521 and transmitter 522. One or more elements among these three types of element examples are set as elements for detection. In the following description, the element utilized for detection will be referred to as a “detecting element”.

Referring to FIG. 11, in step S100, CPU 101 turns off the detecting element (for example, does not supply drive power to a light source and/or a transmitter).

In step S102, CPU 101 retrieves which one of paper feed cassettes 4A to 4D is selected as a paper feed cassette containing a paper sheet intended for image formation. When CPU 101 determines that paper feed cassette 4A is selected, it advances the control to step S104. When CPU 101 determines that paper feed cassette 4B is selected, it advances the control to step S108. When CPU 101 determines that paper feed cassette 4C is selected, it advances the control to step S112. When CPU 101 determines that paper feed cassette 4D is selected, it advances the control to step S116.

In step S104, CPU 101 waits until paper feed sensor 80 of paper feed cassette 4A detects recording paper sheet P2. Then, when paper feed sensor 80 detects recording paper sheet P2, CPU 101 advances the control to step S106.

In step S106, after a lapse of time period T1 (see FIG. 10) since detection of recording paper sheet P2 by paper feed sensor 80, CPU 101 applies a drive voltage for the front end detection time (see FIG. 9) to the detecting element. Then, CPU 101 advances the control to step S120.

In step S108, CPU 101 waits until paper feed sensor 80 of paper feed cassette 4B detects recording paper sheet P2. Then, when paper feed sensor 80 detects recording paper sheet P2, CPU 101 advances the control to step S110.

In step S110, after a lapse of time period T2 (see FIG. 10) since detection of recording paper sheet P2 by paper feed sensor 80, CPU 101 applies a drive voltage for the front end detection time (see FIG. 9) to the detecting element. Then, CPU 101 advances the control to step S120.

In step S112, CPU 101 waits until paper feed sensor 80 of paper feed cassette 4C detects recording paper sheet P2. Then, when paper feed sensor 80 detects recording paper sheet P2, CPU 101 advances the control to step S114.

In step S114, after a lapse of time period T3 (see FIG. 10) since detection of recording paper sheet P2 by paper feed sensor 80, CPU 101 applies a drive voltage for the front end detection time (see FIG. 9) to the detecting element. Then, CPU 101 advances the control to step S120.

In step S116, CPU 101 waits until paper feed sensor 80 of paper feed cassette 4D detects recording paper sheet P2. Then, when paper feed sensor 80 detects recording paper sheet P2, CPU 101 advances the control to step S118.

In step S118, after a lapse of time period T4 (see FIG. 10) since detection of recording paper sheet P2 by paper feed sensor 80, CPU 101 applies a drive voltage for the front end detection time (see FIG. 9) to the detecting element. Then, CPU 101 advances the control to step S120.

In step S120, based on the output from the detecting element, CPU 101 determines whether the front end of recording paper sheet P2 has been detected or not in sensor unit 500. Until the front end of recording paper sheet P2 is detected (NO in step S120), CPU 101 repeats the determination in step S120. When the front end of recording paper sheet P2 is detected (YES in step S120), CPU 101 advances the control to step S122.

For example, when the combination of light receiver 511 and light source 512 is set as the detecting elements, CPU 101 applies a drive voltage for the front end detection time (a voltage E21 in FIG. 9) to light source 512 in each of steps S106, S110, S114, and S118. In step S120, CPU 101 determines that the front end of recording paper sheet P2 has been detected, when the amount of light detected by light receiver 511 is increased as a result of reflection of the light from light source 512 by the front end of recording paper sheet P2.

In step S122, CPU 101 applies a drive voltage for the medium detection time (see FIG. 9) to the detecting element.

In step S124, CPU 101 continues conveyance of recording paper sheet P2 to the position of state ST1 (see FIG. 8).

In step S126, CPU 101 determines whether or not recording paper sheet P2 has been conveyed to the position shown by state ST1. In one implementation, CPU 101 uses another sensor to determine whether it has been detected or not that recording paper sheet P2 is located at the position shown by state ST1. In another implementation, CPU 101 determines whether the time period set in advance has elapsed or not in a time period from detection of the front end of recording paper sheet P2 in step S120 to arrival of recording paper sheet P2 at the position of state ST1. Until recording paper sheet P2 is conveyed to the position shown as state ST1 (NO in step S126), CPU 101 repeats the control in steps S122 to S126. When recording paper sheet P2 is conveyed to the position shown as state ST1 (YES in step S126), CPU 101 advances the control to step S128.

In step S128, CPU 101 samples the signal from the detecting element (the signal from light receiver 511 and/or receiver 521) several times.

In step S130, CPU 101 continues conveyance of recording paper sheet P2 to the position of state ST2 (see FIG. 8). In other words, sampling in step S128 is performed while recording paper sheet P2 is located in a range from the position of state ST1 to the position of state ST2.

In step S132, CPU 101 determines the type of recording paper sheet P2 by using the data sampled in step S128.

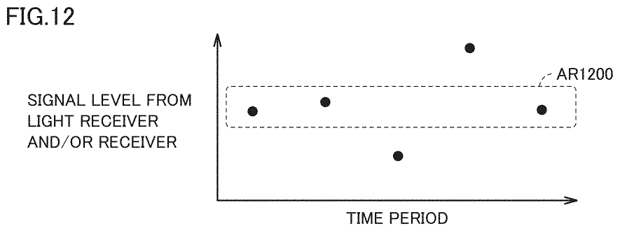

FIG. 12 is a diagram for illustrating an example of a method of determining the type of recording paper sheet P2 using the sampled data. FIG. 12 shows five pieces of sampled data. CPU 101 may select three pieces of sampled data excluding the maximum value and the minimum value from five pieces of sampled data as shown by a broken line AR1200, and perform an equalization process using the selected sampled data to derive a value to be used as a reference of determination. Then, based on this derived value, CPU 101 may derive the result of determination about the type of recording paper sheet P2.

As described above, in the process shown in FIG. 11, the drive voltage for the front end detection time is applied to the detecting element in any one of steps S106, S110, S114, and S118. This corresponds to the process that CPU 101 causes the detecting element to perform the first operation. In this regard, CPU 101 that executes a prescribed program for the process in FIG. 11 is an example of the detection unit.

Then, when the front end of recording paper sheet P2 is detected in sensor unit 500 (YES in step S120), a drive voltage for the medium detection time is applied to the detecting element. The process that CPU 101 controls the drive voltage for the medium detection time to be applied to the detecting element corresponds to the process that CPU 101 causes the detecting element to perform the second operation. Thereby, in the process in FIG. 11, the detecting element is controlled in response to the request to perform the second operation at the timing that is based on the timing at which the front end of recording paper sheet P2 (sheet) is detected by the first operation. In other words, the timing to start the second operation is determined by the signal from the detecting element.

In the process in FIG. 11, the front end of recording paper sheet P2 is detected in step S120, and the type of recording paper sheet P2 is detected in step S132. In the case where CPU 101 utilizes the signal from the detecting element for a time period A for front end detection, and utilizes the signal from the detecting element for a time period B for type detection, time period B may be longer than time period A.

The sheet conveyance apparatus may have an image forming function such as MFP, or may not have an image forming function as long as it has a function to convey a sheet.

Although embodiments of the present invention have been described and illustrated in detail, the disclosed embodiments are made for purposes of illustration and example only and not limitation. The scope of the present invention should be interpreted by terms of the appended claims.

What is claimed is:

1. A sheet conveyance apparatus comprising:
a conveyance path for a sheet;
a conveyance unit that conveys the sheet on the conveyance path;
a sensor unit that performs a first operation for detecting a front end of the sheet and a second operation for detecting a type of the sheet, and outputs signals indicating results of the first operation and the second operation; and
a controller that receives the signals from the sensor unit and detects the front end and the type of the sheet, and causes the sensor unit to perform the second operation at a timing that is based on detection of the front end of the sheet in the first operation.

2. The sheet conveyance apparatus according to claim 1, wherein
the sensor unit includes:
a light receiver; and
a transmission light source that emits light through the conveyance path of the sheet to the light receiver, and
the controller detects the front end and the type of the sheet based on a signal from the light receiver.

3. The sheet conveyance apparatus according to claim 2, wherein
the controller detects the front end of the sheet based on a signal from the light receiver for detecting light from the transmission light source.

4. The sheet conveyance apparatus according to claim 2, wherein
the controller controls the sensor unit such that an amount of light from the transmission light source is less in the first operation than in the second operation.

5. The sheet conveyance apparatus according to claim 1, wherein
the sensor unit includes:
a light receiver; and
a reflection light source that emits light in a direction in which the light is reflected by the sheet on the conveyance path, and
the controller detects the front end and the type of the sheet based on a signal from the light receiver.

6. The sheet conveyance apparatus according to claim 5, wherein
the controller detects the front end of the sheet based on a signal from the light receiver for detecting light from the reflection light source.

7. The sheet conveyance apparatus according to claim 5, wherein
the controller controls the sensor unit such that an amount of light from the reflection light source is less in the first operation than in the second operation.

8. The sheet conveyance apparatus according to claim 5, wherein
the sensor unit further includes a transmission light source that emits light through the conveyance path of the sheet to the light receiver, and
the controller causes the sensor unit to emit light sequentially from the reflection light source and the transmission light source one at a time in the first operation.

9. The sheet conveyance apparatus according to claim 2, wherein
the controller utilizes the signal output in a first time period from the light receiver for detecting the front end of the sheet, and utilizes the signal output in a second time period longer than the first time period from the light receiver for detecting the type of the sheet.

10. The sheet conveyance apparatus according to claim 1, wherein
the sensor unit includes:
an ultrasonic transmitter; and
an ultrasonic receiver disposed to detect, through the sheet on the conveyance path, an ultrasonic wave transmitted from the ultrasonic transmitter, and
the controller detects the front end and the type of the sheet based on a signal from the ultrasonic receiver.

11. The sheet conveyance apparatus according to claim 10, wherein
the controller detects the front end of the sheet based on the signal from the ultrasonic receiver.

12. The sheet conveyance apparatus according to claim 10, wherein
the controller controls the sensor unit such that strength of transmission from the ultrasonic transmitter is less in the first operation than in the second operation.

13. The sheet conveyance apparatus according to claim 10, wherein
the sensor unit includes:
a light source; and
a light receiver that receives light from the light source,
the light receiver is disposed such that a signal output from the light receiver changes between when the sheet exists at a first position on the conveyance path and when the sheet does not exist at the first position on the conveyance path,
the ultrasonic receiver is disposed such that the signal output from the ultrasonic receiver changes between when the sheet exists at a second position on the conveyance path and when the sheet does not exist at the second position on the conveyance path,
the conveyance path includes a first portion including the first position and a second portion including the second position, and
an angle at which the sheet is conveyed is different between the first portion and the second portion.

14. The sheet conveyance apparatus according to claim 13, wherein
the controller detects the type of the sheet based on a signal output from one of the ultrasonic receiver and the light receiver that is disposed upstream in the conveyance path.

15. The sheet conveyance apparatus according to claim 1, wherein
the conveyance path includes a first portion and a second portion that is located downstream from the first portion, and
an angle at which the sheet is conveyed is different between the first portion and the second portion.

16. The sheet conveyance apparatus according to claim 1, wherein
after detection of the front end of the sheet by the first operation, the controller determines a timing at which an impact by contact of the front end of the sheet with the conveyance path is expected to converge as the timing at which the second operation is performed.

17. The sheet conveyance apparatus according to claim 16, wherein
the controller utilizes a prescribed time period as a length of a time period from detection of the front end of the sheet by the first operation to the second timing at which the impact by the contact of the front end of the sheet with the conveyance path is expected to converge.

18. The sheet conveyance apparatus according to claim 1, wherein
after detection of the front end of the sheet by the first operation, the controller causes the sensor unit to perform the second operation until the sheet reaches a nip portion of a roller in the conveyance unit.

19. The sheet conveyance apparatus according to claim 18, wherein
the roller is a resist roller.

20. The sheet conveyance apparatus according to claim 1, further comprising a plurality of cassettes connected to different positions on the conveyance path, wherein
the conveyance unit introduces a sheet from each of the cassettes into the conveyance path, and
depending on which one of the cassettes from which the conveyance unit introduces the sheet, the controller determines a time period from introduction of the sheet into the conveyance path to start of the first operation.

21. A non-transitory recording medium storing a program executed by a processor of a computer, the program, when executed by the processor, causing the computer to:
by a sensor unit, perform a first operation for detecting a front end of a sheet;
detect the front end of the sheet based on a signal from the sensor unit;
by the sensor unit, perform a second operation for detecting a type of the sheet at a timing that is based on detection of the front end of the sheet in the first operation; and
detect the type of the sheet based on a signal from the sensor unit in the second operation.
